(19) United States
(12) Patent Application Publication
(10) Pub. No.: US 2003/0085804 A1
(43) Pub. Date: May 8, 2003

(54) Hall-effect magnetic buzzer

(76) Inventor: Chun-Chieh Wang, Taipei Hsien (TW)

Correspondence Address: HEDMAN & COSTIGAN, P.C., 1185 Avenue of the Americas, New York, NY, 10036, US

(21) Appl. No.: 10/036,592

(22) Filed: Nov. 7, 2001

(51) Int. Cl. G08B 3/00

(52) U.S. Cl. 340/388.1

(57) ABSTRACT

A Hall-effect buzzer includes a housing, a magnet firmly attached to a top side of the housing, and a cover plate covering a bottom open side of the housing. A column is located in the interior of the housing and a coil is mounted around the column. A free end of the column is firmly engaged with a vibrating piece. Two feet of the coil extend outward and are connected to a circuit board attached to the cover plate.

### BACKGROUND OF THE INVENTION

1. Field of the Invention

The present invention relates to a magnetic buzzer, and more particularly to a Hall-effect magnetic buzzer for a foldable electronic device such that by applying the Hall-effect magnetic buzzer, the manufacturing procedure of the foldable electronic device is simplified.

2. Description of Related Art

A foldable electronic device such as a mobile phone, a portable computer, or a PDA (personal digital assistant) typically has a body portion and a cover portion. With reference to FIG. 7, a foldable mobile phone is shown as an example, and the foldable mobile phone includes a body portion (60) and a cover portion (70) pivotally connected to the body portion (60). To control the activation and the deactivation of the foldable mobile phone, a Hall-effect sensor (61) is planted in the body portion (60), and a magnet (71) is also correspondingly attached to the cover portion (70). A buzzer (80) is further planted in the cover portion (70) and referring to FIGS. 5 and 6, the buzzer (80) includes a housing (81) and a cover plate (82) attached to the housing (81). A column (83) is provided in the interior of the housing (81) and a coil (84) is mounted around the column (83). A magnetic ring (85) is then mounted around the coil (84) and a vibrating piece (86) is attached to a side of the magnetic ring (85) close to the cover plate (82). Two feet of the coil (84) extend outwardly and are connected to a circuit board (87) attached to a side of the housing (81) opposed to the cover plate (82). By such an arrangement, when receiving a phone call, the coil (84) is conducted and generates magnetic force to vibrate the vibrating piece (86) so as to physically inform a user of the incoming phone call. To answer the incoming phone call, the user has to pivot the cover portion (70) to an open state. Due to an increase in the distance between the Hall-effect sensor (61) and the magnet (71), the mobile phone is automatically activated by the Hall-effect sensor (61) which is able to detect its escape from the magnetic field of the magnet (71). On the contrary, when the mobile phone is at a folded state, the Hall-effect sensor (61) automatically shuts off the mobile phone by detecting re-entry of the Hall-effect sensor (61) in the magnetic field of the magnet (71).

However, although the foldable mobile phone as described above has the advantage of convenient operation and has been proven to be popular among users, the main disadvantage is that the Hall-effect sensor (61), the magnet (71), and the buzzer (80) are three separate components that have to be respectively planted in the mobile phone. Accordingly, the manufacturing procedure is complicated and needs to be simplified to save time and cost associated with the manufacturing.

Therefore, the present invention tends to provide a Hall-effect magnetic buzzer to overcome the aforementioned problem.

### SUMMARY OF THE INVENTION

An objective of the present invention is to provide a Hall-effect magnetic buzzer that is convenient to be assembled onto a foldable mobile phone. The Hall-effect buzzer includes a housing, a magnet firmly attached to a top side of the housing, and a cover plate covering a bottom open side of the housing. A column is located in the interior of the housing and a coil is mounted around the column. A free end of the column is firmly engaged with a vibrating piece. Two feet of the coil extend outward and are connected to a circuit board attached to the cover plate.

Other objectives, advantages and novel features of the invention will become more apparent from the following detailed description when taken in conjunction with the accompanying drawings.

### BRIEF DESCRIPTION OF THE DRAWINGS

FIG. 1 is an exploded, perspective view of a Hall-effect magnetic buzzer in accordance with the present invention;

FIG. 2 is a cross-sectional view of the Hall-effect magnetic buzzer;

FIG. 3 is a perspective view of a preferred embodiment of the Hall-effect magnetic buzzer applied to a foldable phone;

FIG. 4 is a plan view of the preferred embodiment shown in FIG. 3;

FIG. 5 is an exploded, perspective view of a conventional buzzer;

FIG. 6 is a cross-sectional view of the conventional buzzer; and

FIG. 7 is a plan view of an embodiment of a conventional foldable mobile phone having a Hall-effect sensor, a magnet, and a buzzer.

### DETAILED DESCRIPTION OF THE PREFERRED EMBODIMENT

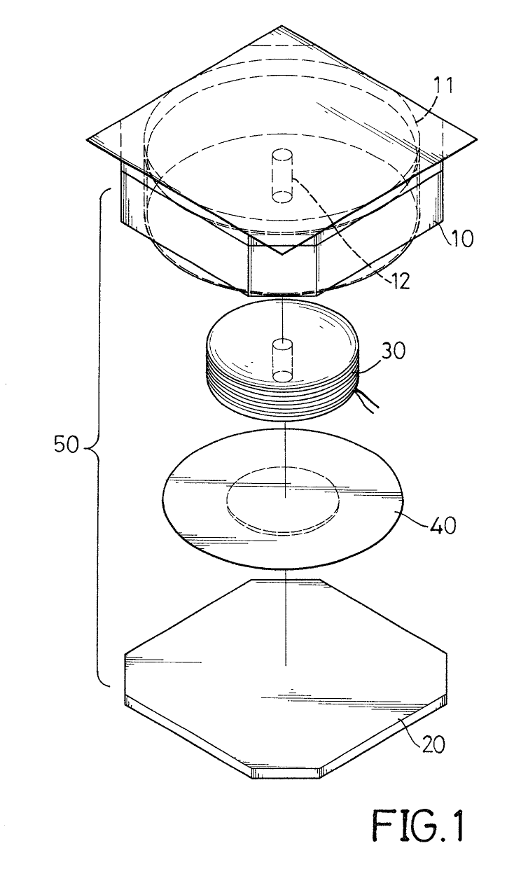

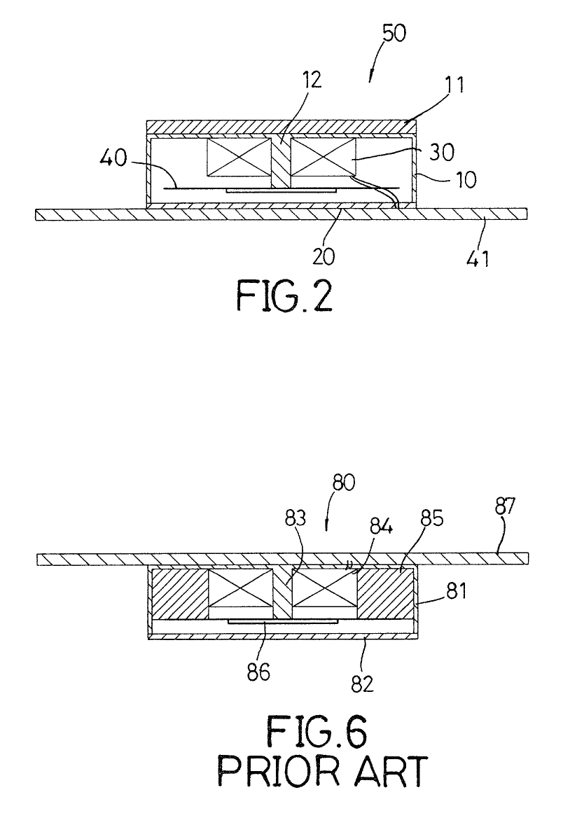

With reference to FIGS. 1 and 2, a Hall-effect magnetic buzzer (50) in accordance with the present invention is shown and includes a housing (10), a cover plate (20), a coil (30), and a vibrating piece (40).

The housing (10) has a top side firmly attached with a magnet (11) and a column (12) located in the interior of the housing (10). The cover plate (20) is securely connected to and covers a bottom open side of the housing (10). The coil (30) is positioned in the interior and mounted around the column (12). The center of the vibrating piece (40) is securely connected with a bottom end of the column (12) close to the cover plate (20). A circuit board (41) is firmly attached to an outer face of the cover plate (20). Two feet of the coil (30) extend out and connect to the circuit board (41).

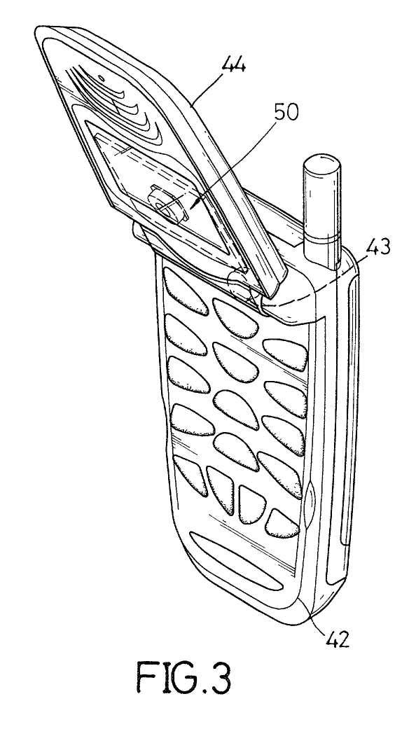

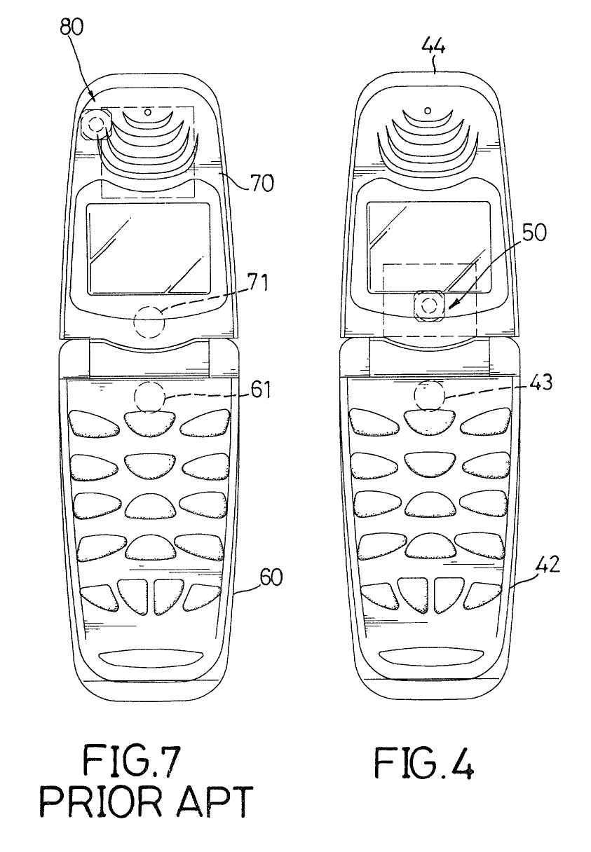

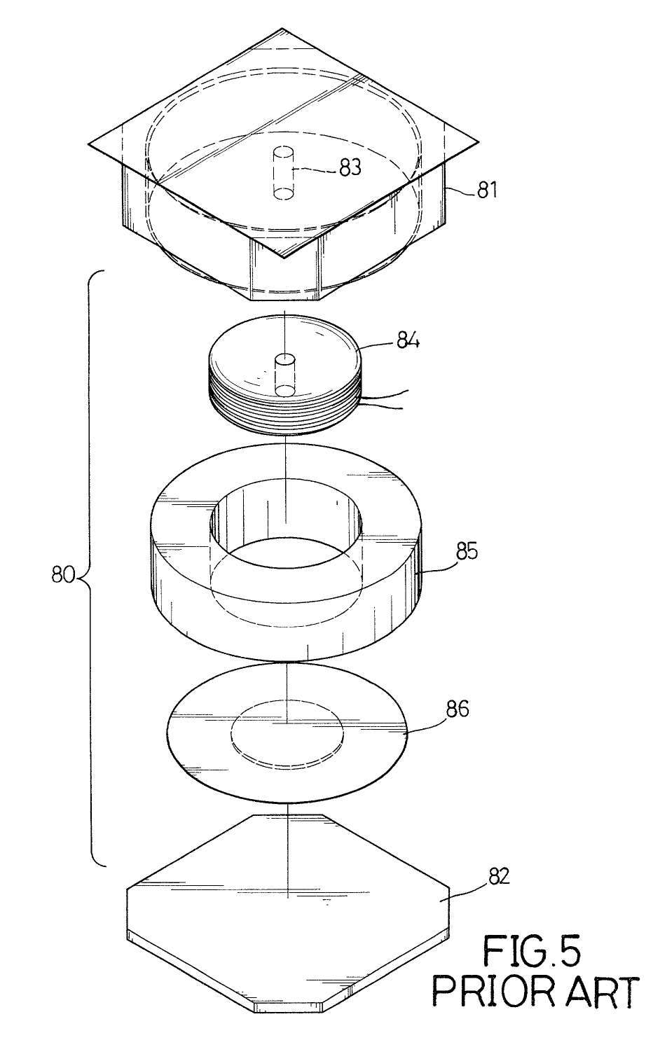

With reference to FIGS. 3 and 4, a preferred embodiment of the Hall-effect buzzer (50) applied on a foldable mobile phone is shown. In the preferred embodiment, the foldable mobile phone has a body portion (42) and a cover portion (44) hinged with the body portion (42). The Hall-effect buzzer (50) is planted in the cover portion (44) and a Hall-effect sensor (43) is correspondingly planted in the body portion (42). The Hall-effect sensor (43) is able to detect the magnetic force and control the activation and the deactivation of the foldable phone. Therefore, when a user pivots the cover portion (44) to an open state to operate the mobile phone, the distance between the magnet (11) and the Hall-effect sensor (43) increases and results in escape of the Hall-effect sensor from the magnetic field of the magnet (11). The Hall-effect sensor (43) detects this escape from the magnetic field and activates the mobile phone automatically. On the contrary, when the cover portion (44) is in a folded stated, the distance between the magnet (11) and the Hall-effect sensor (43) decreases and results in the Hall-effect sensor (43) being influenced by the magnetic field, whereby the Hall-effect sensor (43) detects this change and automatically deactivates the mobile phone to a stand-by condition. The vibrating piece (40), which vibrates in a conventional manner to physically alert a user to an incoming call, is well-known in the art and thus not described in further detail.

It should be appreciated that the main advantage of the Hall-effect buzzer (50) is that the magnet (11) is combined in the Hall-effect buzzer (50). Therefore, when applied onto the foldable mobile phone, only two components, that is the Hall-effect buzzer (50) and the Hall-effect sensor (43), are planted instead of three components, that is the Hall-sensor (61), the magnet (71), and the buzzer (80), used in prior art. Accordingly, the manufacturing procedure of the foldable mobile phone is simplified with the use of the Hall-effect buzzer (50) and the cost and time associated with manufacturing is saved.

While this invention has been particularly shown and described with references to the preferred embodiment thereof, it will be understood by those skilled in the art that various changes in form and details may be made therein without departing from the scope of the invention encompassed by the appended claims.

What is claimed is:

1. A Hall-effect buzzer comprising:
a housing having a column located in an interior of the housing;
a coil mounted around the column and having two feet extending out from the coil and adapted to be connected to a circuit board;
a vibrating piece securely connected to a bottom end the column; and
a magnet attached to a top face of the housing.

2. The Hall-effect buzzer as claimed in claim 1 further comprising a cover plate to cover a bottom opening defined in a bottom face of the housing.
